(19) United States
(12) Patent Application Publication
(10) Pub. No.: US 2004/0128651 A1
(43) Pub. Date: Jul. 1, 2004

(54) Method and system for testing provisioning and interoperability of computer system services

(76) Inventor: Michael Lau, Boulder, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/334,286

(22) Filed: Dec. 31, 2002

(51) Int. Cl. G06F 9/44

(52) U.S. Cl. 717/124; 717/104; 717/106

(57) ABSTRACT

A method for testing software and hardware components or systems for services provisioning or interoperability with hardware and software of a computer system. A testing model is built for the system including representations of the proposed service or software component, the hardware and software components of the computer system, and a provisioning or interoperability test. The test is applied to the representation of the proposed software, hardware, or system component and a report is generated providing results of the application of the test indicating applied tests and providing a visual cue of the severity of any interference, provisioning level, or non-interoperability. The generating includes creating new software, hardware, or system parameters including a level of optimization of a determined provisioning problem. The testing model is a jagged array with a row provided for proposed services or software component with row elements storing operating parameters of software, hardware, or system.

### BACKGROUND OF THE INVENTION

1. Field of the Invention

The present invention relates, in general, to software, hardware, and system testing and to methods of determining optimized configurations and capacities to deliver computing services or whether or not to adopt a new software tool or application or to perform a software migration, and, more particularly, to software, hardware, systems, and methods for testing services provisioning or interoperability of software tools and applications within a wide range of computing environments, e.g., from standalone computers to complex information technology (IT) environments to data centers and web-based networks, in a manner that tests proposed software additions and changes against multiple system parameters and with existing software and computing architecture and that provides quantitative and qualitative visual results that are readily interpreted by testing personnel.

2. Relevant Background

In today's economy, businesses operate in computer-centric environments. Business functions, such as financial accounting, inventory management, business transaction, employee portal, and customer relationship management, all require a suitable computing infrastructure or environment. Computing services provided by these infrastructures and environments, from standalone computers to complex information technology environments, should be provisioned to meet fluctuating priorities and requirements.

In the computer and IT industry, the introduction of new software, such as a new software tool or a newer version of an existing application, operating system, and the like, to a computing system is a difficult task to manage and to perform with minimal disruption to users of the computing system. This “software migration” activity may involve upgrading from one version to another version of a product, may involve changing from one vendor's product to another vendor's product thus involving the removal of one software tool and the addition of a new tool, and may involve moving from one operating system to another or a newer version of the operating system.

For a software migration and provisioning to be successful, the added or modified software tool needs to be compatible with the hardware in the system, such as memory capacity, processing speeds, and the like, and also, interoperable with the existing or planned software tools, applications, and operating system of the computer system upon which it will be installed and operated. Many software tools and applications are distributed with a listing of system requirements that are needed for the tool or application to operate (such as those found on a package of a new software application, e.g., a word processing program) but this listing is typically limited to hardware requirements and acceptable operating systems with little or no effort being made to foresee compatibility or interoperability successes and problems with other software tools and applications that may already be run within computer systems.

The requirements of hardware compatibility and software interoperability are even more important for computing systems that are considered mission critical. Software migrations and services provisioning within mission-critical systems or involving mission-critical tools and applications require careful architecture planning, skillful implementation of the new or revised tool or application, and often ongoing management of the newly created IT environment. Software tools are indispensable for managing complex IT environments, such as data centers, but often the management tools, such as asset management tools, interfere with products from another vendor and interfere with other running software applications or with other tools. Severe interference or lack of interoperability of the software tools and applications can result in system crashes or at the least in poor performance of the new tool or existing tools and applications.

Some software testing and compatibility tools have been developed for use in managing software migrations. Unfortunately, these tools typically are limited to verifying the compatibility of the new or revised software tool or application with existing hardware or a single software program. Existing testing methods do not provide adequate functionality in testing interoperability of a new or revised software tool or application within a complex IT environment in which multiple hardware configurations may exist and be used to run the tool or application and do not facilitate efficient comparison of the new or revised tool or application with the operation of the plurality of existing software tools and applications. Numerous parameters may affect the operation of the new software tool or application and its interoperability with the existing hardware and software system, but no existing tool adequately provides a system manager with feedback prior to actual installation of the software tool or application of possible operating problems and impacts.

Hence, there remains a need for an improved method and system for use in determining the likelihood of successful service provisioning and/or in testing the interoperability of software tools and/or applications within a complex (or simple) IT environment prior to performing a software migration. Such a method would preferably provide a testing engineer with quantitative test results as well as qualitative results in a manner that allows the engineer to readily spot potential operating problems and ensure no or little interference. Further, such a method would preferably facilitate determining the whether provisioning of a service component is likely to be successful and facilitate testing the proposed tool or application against a large number of operating parameters dictated by the hardware and/or software configuration of the existing or planned IT environment.

### SUMMARY OF THE INVENTION

The present invention addresses the above problems by providing a method (and corresponding software and hardware components) for use in testing the provisioning of computing services and/or the interoperability of a proposed software addition (such as the adding of a new software tool or application) within an existing computer system, such as a standalone computer or a networked computer system or a more complex IT environment (such as a data center). The method calls for modeling the testing process by creating a data structure representing and, in some cases storing, raw operating parameters of the proposed software and existing system software and hardware and the interoperability tests (or references to such tests). In one aspect of the invention, the testing model utilizes jagged arrays (also known as jagged multidimensional arrays or arrays of arrays) to itemize, organize, correlate, and visualize the individual test factors and, importantly, the combined or collective effects of the proposed software.

For example, a row in the jagged array may represent the proposed software addition (or modification or upgrade) or provisioned service component. Each element of the row in the array is occupied by product operating and test parameters such as hardware requirements, application software platform compatibility, configuration parameters, memory requirements, storage requirements, operating system and version compatibilities, operating standards and benchmarks, input and output data formats, user and transaction loading, and the like. The number of software tools and applications, both new and existing, and the number of parameters and tests define the initial dimensions of the testing model or array. A testing set is then defined for the proposed software or service component from the other rows of the testing model and applied to the proposed software or service component row elements. The results of mathematical and/or logical processing of each element or series of elements in the proposed software row can then be stored as a new row (such as a results row) changing the dimensions of the testing model or be combined into the original software row elements. The results can be displayed in a report providing the results of each test applied to the proposed software or service component. Alternatively, the results may be shown visually on multiple acceptability or severity levels or levels of provisioning success. For example, color cues may be used to show the results of each testing element, e.g., the results row added to the testing model may be color-coded such that a red element indicates failure of the test element, a yellow element shows that some issues may be presented (i.e., a qualitative result) with the proposed software based on this test element, and a green element indicates passing of the test element.

More particularly, a computer-based method is provided for testing software components for interoperability with the hardware and software components of a computer system or IT operating platform of varying complexity. The method includes building a testing model for the computer system including representations of the proposed software component, the hardware and software components of the computer system, and at least one interoperability test. The interoperability test is then applied to the representation of the proposed software component and a report is generated providing the results of the application of the interoperability test, e.g., with a combination of text indicating which tests were applied and also providing a visual cue, such as a color-coded indicator, of the severity of any interference or non-interoperability.

In one embodiment, the testing model is a jagged array with a row provided for the proposed software component with the row elements storing operating parameters of the software. The interoperability test typically is also built as a part of the method based on the testing parameters provided or gathered for the hardware and/or software components of the computer system.

In another aspect of the invention, a computer-based method is provided for testing services provisioning with a computer system or operating platform. The method includes linking a testing system having a remote testing agent to a communications network and then receiving a request for the provisioning of a service component on a particular computer system. The method continues with determining a set of operating parameters for the service component and collecting hardware and software parameters for the computer system identified in the request. Provisioning tests are then developed based on the collected hardware and software parameters. The provisioning tests are then applied to the operating parameters of the services component. A provisioning report is generated based on the application of the provisioning tests and typically transmitted to or displayed to the requesting entity.

### BRIEF DESCRIPTION OF THE DRAWINGS

FIG. 1 illustrates in block diagram form an interoperability testing system of the present invention showing a testing system for providing remote testing of software migrations for networked computing systems and IT environments and onsite testing using an installed testing module and/or system;

FIG. 2 is a flow chart illustrating exemplary functions performed by a testing system (onsite or remote) according to the invention to test proposed software tools and applications prior to installation and to provide results in a useful manner to testing personnel;

FIG. 3 illustrates one embodiment of a testing model utilizing a jagged array configuration for storing proposed software parameter as well as existing system operating parameters (software and hardware configurations) and interoperability tests;

FIG. 4 is a testing report generated by the testing systems of FIG. 1 providing results in table form;

FIG. 5 is another testing report generated by the testing systems of FIG. 1 providing results in visual (i.e., color-coded form) for display to a user or testing personnel in isolation or within the testing model when stored back within the model as a new row or test results row;

FIG. 6 illustrates another embodiment of a testing model utilizing a jagged array configuration similar to FIG. 3 used for storing the results of a user setting comparability test for a computer system; and

FIG. 7 illustrates yet another embodiment of a testing model similar to FIGS. 3 and 6 showing the use of the jagged array features of the invention for providing a plurality of rows and columns for two computer systems and storing operating parameters (and, in some cases test results) in elements within the rows for the computer system hardware and software.

### DETAILED DESCRIPTION OF THE PREFERRED EMBODIMENTS

The present invention is directed to methods and systems for testing the provisioning of computing services or the effects of a planned software migration, such as the installation of one or more new software tools or applications or the upgrading from one version to a new version for an existing software module, on a computing system. More particularly, the invention is directed to determining the provisioning of computing services or the interoperability of a proposed software tool or application with existing hardware and software within a computing system. The computing system may be a simple personal computer or be a complex IT operating platform (or other system with varying complexity) and may include any of a number of operating platforms and architectures utilizing a variety of operating systems, hardware configurations, and a wide range of running or existing software. The methods and systems of the invention are useful for testing the interoperability of the proposed software with the existing hardware and software of the computing system and for reporting the results of such tests to testing or IT management personnel (such as with visual cues). As will become clear, the results include quantitative results and, typically, qualitative results (such as potential problems or less than optimal compatibility).

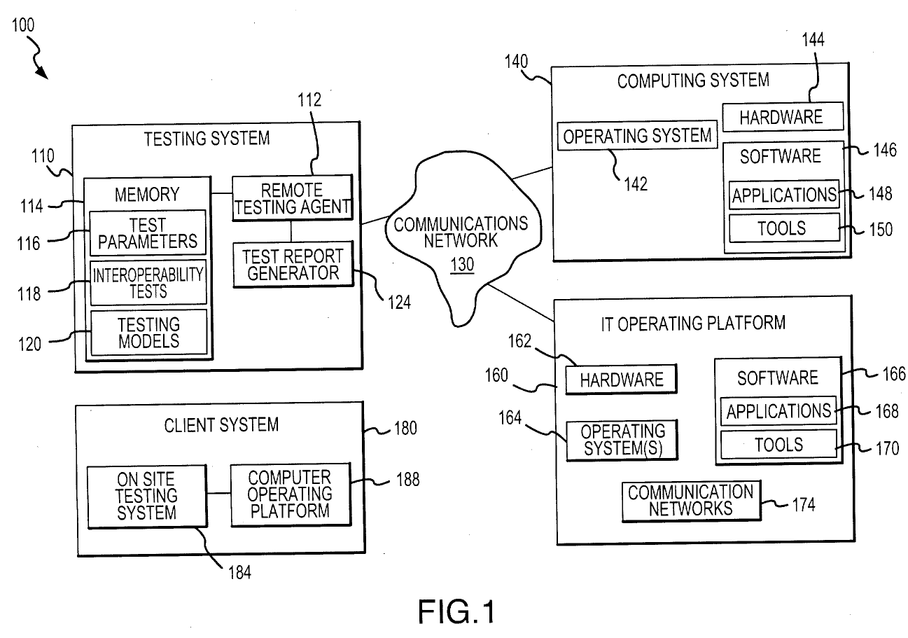

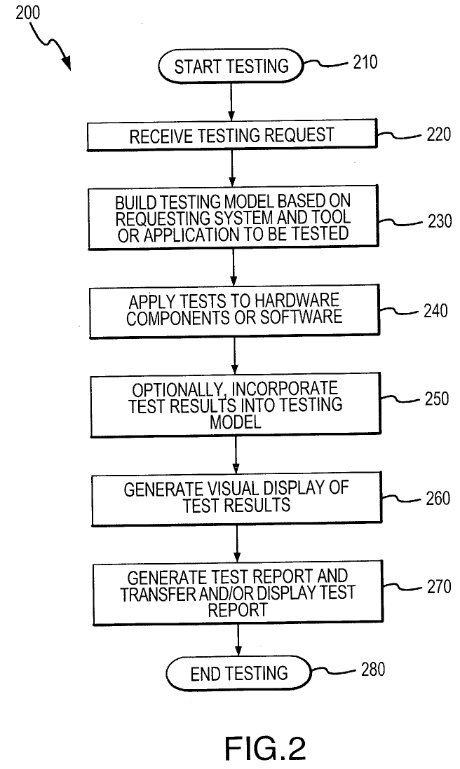

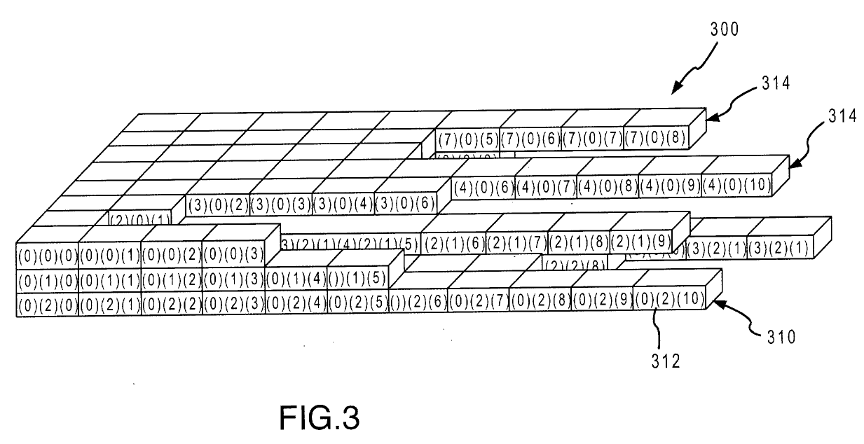

The following description begins with a general description of an interoperability testing system 100 with reference to FIG. 1 that illustrates how the systems and methods of the present invention support testing of compatibility of planned software (either remotely or in situ) on an existing system (or even a planned system) based on numerous operating parameters of the planned software and the existing system as well as based on specific interoperability tests. The functions performed by a testing system or testing module are explained in more detail with reference to FIG. 2 along with further reference to FIGS. 3-7, which illustrate one testing model of the present invention used to store raw system, testing, and planned software parameters and to model the testing environment or process and illustrate result reports generated by the system.

In the following discussion, computer and network devices, such as the software and hardware devices within the testing system 10, the computing system 140, the IT operating platform 160, and the client system 180, are described in relation to their function rather than as being limited to particular electronic devices and computer architectures. To practice the invention, the computer and network devices may be any devices useful for providing the described functions, including well-known data processing and communication devices and systems, such as database and web servers, mainframes, personal computers and computing devices and mobile computing devices with processing, memory, and input/output components, and server devices configured to maintain and then transmit digital data over a communications network. Data, including requests for interoperability tests and test results and transmissions to and from the elements 110, 140, and 160 and among other components of the system 100 typically is communicated in digital format following standard communication and transfer protocols, such as TCP/IP, HTTP, HTTPS, FTP, and the like, or IP or non-IP wireless communication protocols such as TCP/IP, TL/PDC-P, and the like.

FIG. 1 illustrates an interoperability testing system 100 according to the present invention adapted for testing the effects of software changes on a computer system or operating platform or environment. As shown, the system 100 includes a testing system 110 linked to the communications network 130 (such as the Internet or other digital communication network such as a LAN or WAN using wired or wireless communication technologies). Also connected to the network 130 are computing system 140 and IT operating platform 160. The system 100 further includes a standalone client system 180.

The computing system 140 is representative of relatively simple computing platforms or systems including a particular operating system 142 and a set of hardware (including software components to provide functionality) 144 such as processors, memory, communication systems (such as networks, busses, and more) and the like. The computing system 140 further includes a particular software arrangement or architecture 146 that is operating or operable on the system 140 that includes a set of applications 148 and tools 150 for providing particular functions, e.g., word processors, data management modules, graphics programs, spreadsheet programs, and the like. The IT operating platform 160 is representative of more complex computing environments such as data centers or large corporate computing networks that may include a large number of computing devices and systems networked together. The IT operating platform 160 may include a large set of hardware components 162, one or more operating systems 164, and one or more communication networks 174 with associated hardware and software. Additionally, the IT operating platform 160 includes a set of operating or operable software 166 including numerous applications 168 and tools 170. As can be expected, each of the these features of the computing system 140 and IT operating platform 160 may affect the operation of a newly installed software module (or new version of the software 146, 166) or may be affected by the installed new software module (i.e., the installed software may operate properly or as expected yet cause reduced operability of existing hardware or software).

To determine such operation effects, the system 100 includes a testing system 110 that is linked to the communications network 130 to receive and process interoperability testing requests from the computing system 140 and the IT operating platform 160. The testing system 110 includes a remote testing agent 112, and the operation of the testing agent 112 is discussed in detail with reference to FIGS. 2-7. Generally, the remote testing agent 112 functions to gather operating parameters for the requesting device (such as existing software and hardware components and configurations) and to store these in memory 114 as test parameters 116 for the requesting system 140 or 160. The remote testing agent 112 further stores in memory 114 a set of interoperability tests 118 that may be general tests useful for determining the compatibility of two software tools or applications or compatibility of a software tool or application with any given hardware arrangement. Alternatively, the interoperability tests 118 are developed by the remote testing agent 112 based on the particular components and configuration of the requesting system 140 or 160 (such as one or more tests for a planned software tool or application based on the operating system 142, 164, the hardware 144, 162, and/or the software 146, 166).

Significantly, the remote testing agent 112 builds a testing model 120 based on the test parameters 116 and the interoperability tests 118 as well as the planned software tool or application addition for the requesting system 140, 160. The testing model 120 may take a number of forms that are useful for generating a testing process based on numerous interrelated operating parameters and tests. In other words, the planned software tool or application needs to be tested for interoperability not only with the hardware but also with multiple software components within the existing system. Further, it may be necessary to retest existing software based on the hardware changes caused by the addition of the new software (i.e., overall memory availability may be affected, processing availability may be affected, and the like).

The remote testing agent 112 further performs testing of the proposed software tool or application based on the created testing model 120. For example, a set of tests may be developed by selecting a set of the interoperability tests 118 and by comparing the raw test parameters 116 within the testing model 120 with the proposed software tool or application. The results of such testing may be quantitative (such as simple go/no-go or pass/fail results) and/or be qualitative (such as technically compatible but results in reduced operating effectiveness of the proposed software or one or more of the existing software components). The testing system 110 further includes a test report generator 124 for processing the test results created by the testing agent 112 and creating result reports that provide the results of the tests to testing personnel (such as operators of the testing system 110 or the requesting system 140, 160). The results may be stored (not shown) in the memory 114 and/or transferred to the requesting system 140, 160 for viewing, storing, printing, and/or further manipulation. The reports may be primarily textual such as a table or include graphics and/or color cues or coding to provide users of the reports with visual cues as to the quantitative and/or qualitative results of the testing.

Testing system 110 is used for remote testing of client systems but the system 100 may include one or more client systems 180 that are adapted for onsite testing of planned software migrations. For example, the client system 180 may be a computing system or IT operating environment similar to systems 140, 160 but that includes a downloaded testing module or programs (that may be delivered by the testing system 110 or otherwise provided and loaded on the client system 180) to allow IT managers of the system 180 to selectively perform interoperability testing without third party input. As shown, the client system 180 includes an onsite testing system 184 that may be configured similarly to the testing system 110 or include only the remote testing agent 112 and the test report generator 124 and use shared memory. The system 180 also includes a computer operating platform 188 for which interoperability testing is performed by the onsite testing system 184. Such an onsite arrangement is useful for allowing IT management personnel to plan periodic software migrations by running one or more possible scenarios and then comparing the results without the need for contacting the testing system 10 and waiting for result reports. For example, it is often useful for an IT manager to determine which of two migration paths is more desirable (such as choosing between two vendor products having similar functionality or deciding between moving to a new vendor's product or installing a new version of an existing software tool or application).

FIG. 2 illustrates generally a testing process 200 that may be performed by the system 100 and is explained with reference to the testing system 1 10 (although it should be understood to apply to the onsite testing system 184 with only minor modifications). The testing 200 is started at 210 typically by establishing and/or initializing the testing system 110, linking the system 110 to the network 130, and providing access to the system 110 to potential clients 140, 160. At 220, the testing process 200 continues with receiving a testing request from a client 140, 160. Typically, the request will identify a proposed software migration, i.e., what software tool(s) and/or application(s) are planned to be installed on the existing client system 140, 160 (or on portions of such systems) or this information can be identified at a later time. The proposed or planned software is stored in the memory 114 for later use in creating a testing model.

At 230, the process 200 continues with the remote testing agent 112 building a testing model 120. The testing model 120 is built to represent the existing system 140, 160 of the requesting party and the proposed software addition or change. To this end, the remote testing agent 112 may request system information (such as information on the operating system 142, 164, the hardware 144, 162, the software 146, 166 and other information such as the communication networks 174) or may perform automated data gathering by remotely searching, querying, and/or otherwise inspecting the clients 140, 160. At this time, the requester may provide planned configurations of their systems 140, 160 in addition to actual existing architectures and operating environments, such as when an IT manager is creating a computing system and desired knowledge of the interoperability of the components. The gathered system information is processed by the remote testing agent and then stored as testing parameters 116 in memory 114.

Additionally, the remote testing agent 112 may develop specific interoperability tests 118 based on the raw parameters 116 (e.g., tests that generally should be performed on any software based on the client's operating system or hardware configuration and the like) or the tests 118 may include more generalized tests that apply generally to any software migration (e.g., processing requirements, memory requirements, communication requirements, and the like). Further, according to an important feature of the invention, the remote testing agent 112 places the test parameters 116 and interoperability tests 118 applicable to the client request or requesting system 140, 160 into the testing model 120. The model 120 may take numerous forms useful for relating numerous testing or raw parameters to tests and proposed software parameters or requirements.

FIG. 3 illustrates one embodiment of a testing model 300 that comprises a jagged array, e.g., an array whose elements are themselves arrays, in which each row represents a set of test parameters, a software module (existing or proposed), or a set of tests. For example, the row 310 may represent the proposed software tool or application addition with each element 312 being associated with the operating parameters for the proposed tool or software, such as memory requirements, data format requirements, processing requirements, compatible operating systems, and the like. The other rows 314 of the model array 300 are used to store raw testing parameters (such as the requirements of the other operating software tools and applications or hardware components and configurations of the requesting system) and interoperability tests (individually or combined to create a series of tests for the particular proposed software in row 310). For example, each test may be written as a script and be structured as an element of the array 300. For tests that only have executables, the array element may be a call to an interoperability test 118.

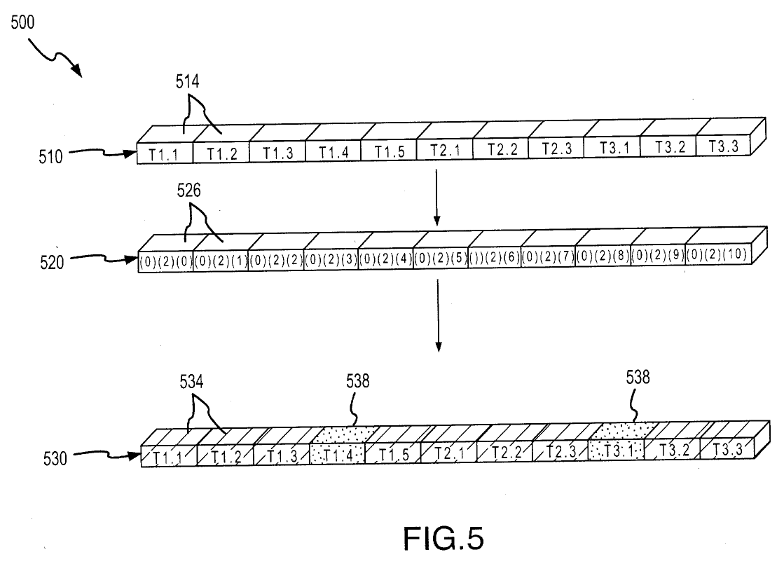

Once the testing model 120 (shown as 300 in FIG. 3) is built, the remote testing agent 112 acts at 240 to test the interoperability of the proposed software within the now modeled computing system or operating platform. As discussed above, the interoperability testing may involve applying one or more tests (such as rows in a jagged array representing tests or series of tests) to the modeled proposed software (such as a row within jagged array 200). For example, FIG. 5 illustrates such a test application step 240 as a stepped testing function 500 in which first an interoperability test is selected from the model, such as a testing row 510 of a jagged array 200 as shown with each element 514 representing one test to be applied to a proposed software. The modeled software is then retrieved from the model as shown by row 520 with elements 526 representing operating parameters or requirements of the proposed software. Then, in step 240, each of the elements 514 are applied to the software modeled as array row 520 and elements 526. At 250, the results of the tests can be incorporated back into the array 200 such as by creating a new test results row, by altering the software modeling row 530, and/or by altering the testing row 510.

At 260, a visual display of test results is provided by the remote testing agent 112. For example, as shown in FIG. 5, the test results may be shown by adding color cues or indicators for the testing row 510. The resulting test result row 530 then may have test elements in array boxes or elements 534 that have passed the test represented by the element 534 shown with a particular color code (or other visual indicator), such as the color green that is indicated in FIG. 5 with crosshatch lines. Test elements 538 were failed and are shown with a different color code (or other visual indicator different than used for elements 534) such as the color red as indicated in FIG. 5 with dots. In some cases, qualitative results may also be provided such as a level of interoperability that is between complete acceptability or compatibility and unacceptability or incompatibility. In these cases, a third (or fourth or fifth and so on) color coded box can be displayed, such as yellow, to indicate that potential problems relating to the test may exist and if multiple intermediate results are generated than the severity of such problems can be indicated, such as some level of expected interference with another software tool, some slowing of processing within the system, and the like. The results row 530 can be displayed to a user of the testing system 110 (or transferred for viewing on the requesting system 140, 160 or as part of a report as discussed with reference to step 270). The results row 530 can then be stored back into the model 200 to provide visual cues within the model 200 that are readily seen and understood by test personnel.

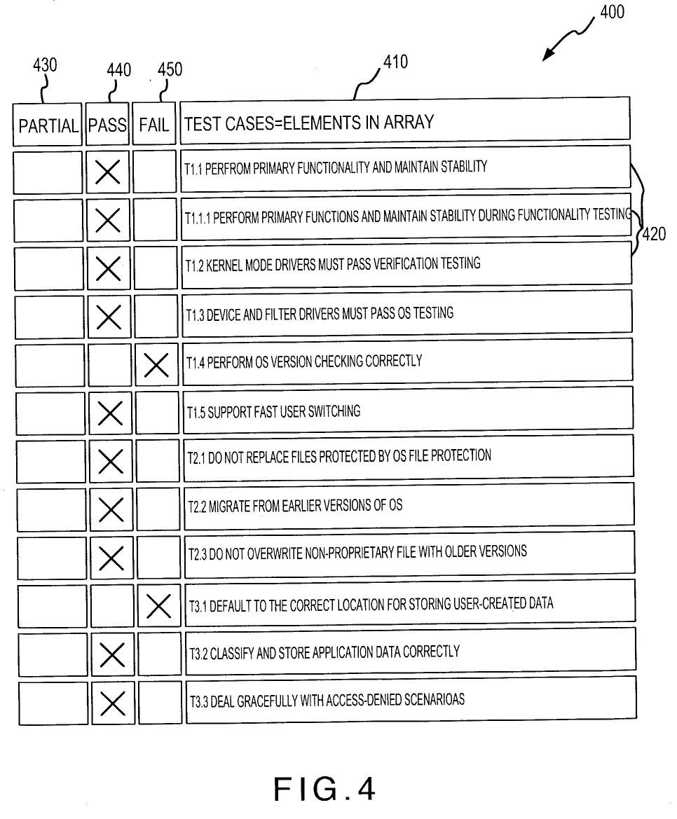

At 270, the test report generator 124 acts to create a report based on the interoperability testing of step 240 and to transfer the report to the requesting system 140, 160 (and, optionally, to display/store the report on the system 110). The report may take numerous forms, such as the color-coded test row 530 shown in FIG. 5 possibly with the addition of a color code key and a listing of which tests were performed for each element in the row 530. In another embodiment, the test report 400 may take the table form shown in FIG. 4 that utilizes text more heavily. As shown, the report 400 provides a column 410 listing the test cases applied to the proposed software (and which in this case correspond to elements in a jagged array taken from three rows).

The tests 420 shown in column 410 are exemplary of the types of tests than may be applied to determine the interoperability of a proposed software, but are not intended to be restrictive of the invention as the possible tests that may be found useful are very large in number and may vary from system to system and on the goals of testing personnel. As shown, the tests 420 include qualitative as well as quantitative tests. As a result, it is useful to display the results of the test with at least three columns 430, 440, 450 to allow tests to be shown as passing tests (column 440), failing tests (column 450), and also partially passing tests (column 430). The partial pass column 430 allows users of the report to understand that further testing or investigation may be required or to understand that while the proposed software is strictly interoperable with the existing system (or other parameter of the particular test) that the proposed software or portions of the system may not behave at highest levels. The report, at 270, is then transferred and/or displayed to a user or the requesting party (i.e., to the requesting system 140, 160). At 280, the testing process 200 is terminated and the system 110 waits for additional testing requests.

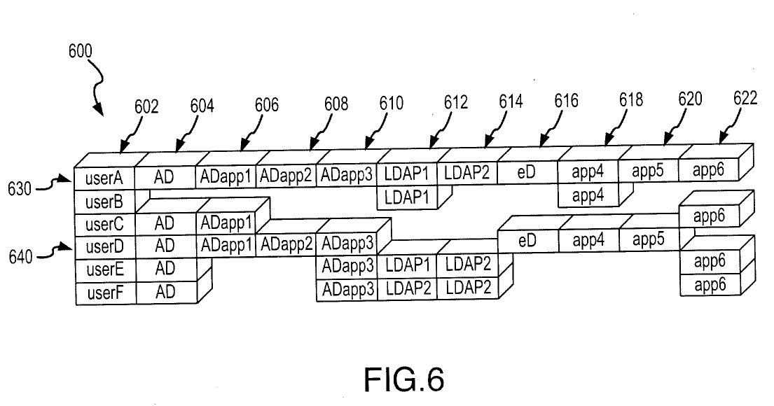

FIG. 6 provides another example of how a testing model according to the invention may be implemented. The illustrated model 600 shows the use of a jagged array for modeling a plurality of users and their user settings within a computer system, which can then be used in testing the user settings for interoperability or compatibility with particular software and/or hardware in a computer system. As shown, the model 600 includes a number of columns with column 602 representing a particular user or user element and columns 604-622 including elements representing or storing various user settings for the user. The user settings typically will vary among computer systems but generally will include such items as a user identifier, a user password, access rights to various applications, hardware settings, and the like. These user settings often will vary between directory structures, such as Microsoft™ Active Directory (AD), Novell™ eDirectory (eD), lightweight directory access protocol (LDAP), and the like.

Each user is modeled with a different row 630, 640 having a number of elements in columns 604-622 corresponding to the user settings, which visually provides a profile for the user based on their settings. Interoperability testing, is then performed, on each user and may include testing password synchronization, checking client side cookies, verifying web page caches, and the like. The results of the testing are stored in a separate test result row (not shown) as discussed above or stored in the user elements in column 602. The results provide an accurate user profile (or can be processed further to create a useful user profile) that is readily retrieved for use by system administrators, such as for facilitating single sign-on processes.

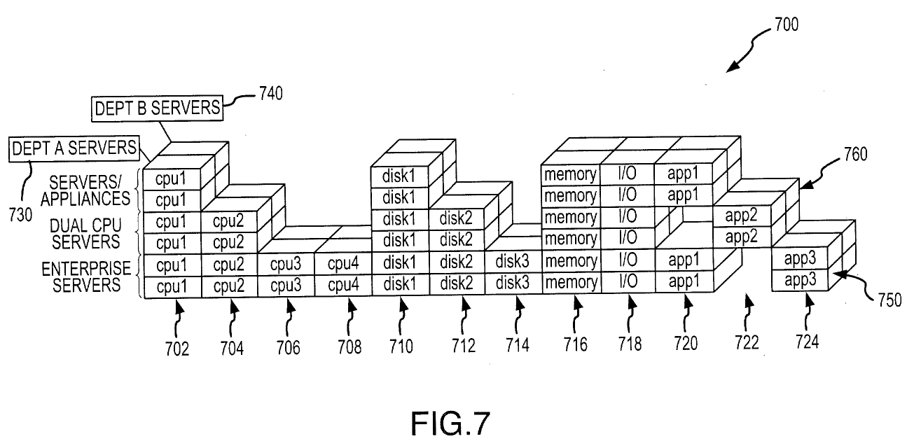

FIG. 7 illustrates a simplified example of application of the testing processes of the invention to provisioning of resources within a computer system. As shown, the testing model 700 is formed by modeling servers of two department computer systems or IT operating environments 730, 740 as series of rows 750, 760 each including a number of columns (or row elements) 702-724 representing each resource of the servers 730, 740. As shown, each department system 730, 740 includes six servers that perform different functions within the systems 730, 740, which results in different numbers of elements in the rows 750, 760 representing the resources of that server.

Two of the servers are single processor servers or appliances that only have one software application running (e.g., “app1” which may be a web server application and the like) and hardware resources (e.g., a disk, memory, and I/O). Two of the servers are dual processor servers running a different software application than the first servers (i.e., “app2”) and hardware resources. The other two servers are shown to be quad processor servers running two software applications (i.e., “app1” and an “app3” which may be a database server application). Each resource within the systems 730, 740 is represented in the model 700 as an element (in columns 702-724) in the jagged array model, such as processor usage (cpu1 to cpu4), disk drive usage (disk1 to disk3, memory usage (memory), traffic bandwidth (I/O), and software applications (app1 to app3). In some embodiments, UNIX such as “df”, “iostat”, “prtvtoc”, “du”, and other UNIX commands are used to detect usage or utilization.

Once these or other operating parameters are determined with these commands or otherwise, the values of the parameters are represented numerically and/or in a color-coded manner (such as using blue or green for low utilization then red for high utilization and other colors for intermediate utilization). One of the tests (such as tests 118 in FIG. 1) that is applied in some embodiments of the invention is a load simulator. More particularly, a load simulator script is stored in a testing row element (or otherwise retrieved) and then applied to determine practical peak load in a particular system operating environment (e.g., with a particular hardware and software arrangement).

Then, adding new elements to the model 700 that contain test results such as peak load configurations can be used by a testing system (such as system 110 in FIG. 1) to trigger optimization tools (not shown), such as dynamic reconfiguration tools known in the art, to automatically (or with some operator input) to optimize performance by reconfiguring settings within the systems 730, 740. Optimization may include automated workload management, which is typically either intentional under-provisioning (such as for e-mail transmissions, for protecting against security attacks, and the like) or over-provisioning (e.g., to account for anticipated peak loads like e-commerce transactions during a holiday season).

As can be seen by the example provided in FIG. 7, the interoperability testing techniques and systems described herein can significantly simplify and limit hands-on management of IT services. The interoperability testing may be thought of as including a tested permutation of various settings of operating parameters in a real or actual user environment at known, determined, or planned performance levels. In contrast, prior to the invention, testing used static and, often, arbitrary performance best practices or IT management involved simply reacting when preset thresholds of a single component or parameter has been exceeded. For example, an IT manager may adjust settings or resources of a system when utilization of a disk drive was detected or determined to be over a set point, such as 80 percent.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A computer-based method for testing provisioning of computing services with hardware and software components of a computer system, comprising:
building a testing model of a computer system including a representation of a proposed service component, a representation of software components of the computer system, and a representation of hardware components of the computer system and including a representation of a services provisioning tests;
applying the services provisioning test to the representation of the proposed software and hardware component; and
generating a report including results of the applying of the services provisioning test.

2. The method of claim 1, wherein the representation of the proposed service component includes operating parameters for the proposed software component.

3. The method of claim 1, wherein the representation of the proposed service component includes operating parameters for the proposed hardware component.

4. The method of claim 1, wherein the testing model comprises a jagged array, and further wherein the representation of the proposed service component comprises an element or a row of the jagged array.

5. The method of claim 4, wherein operating parameters for the proposed service component are stored in an element or elements of the jagged array row.

6. The method of claim 5, wherein the representation of the services provisioning test comprises another row of the jagged array.

7. The method of claim 6, further including storing the results of the applying into the jagged array.

8. The method of claim 7, wherein the storing includes modifying the test row of the jagged array to provide visual cues of the results of the applying.

9. The method of claim 1, wherein the generating includes creating a report that provides visual indicators of the results of the applying including a level of severity of a determined provisioning problem for the proposed service component.

10. The method of claim 1, wherein the generating includes creating new software parameters or indicators of the applying including a level of optimization of a determined provisioning problem for the proposed service component.

11. The method of claim 1, wherein the generating includes creating new hardware parameters or indicators of the applying including a level of optimization of a determined provisioning problem for the proposed service component.

12. A computer-based method for testing software component interoperability with hardware and software components of a computer system, comprising:
building a testing model of a computer system including a representation of a proposed software component, a representation of software components of the computer system, and a representation of hardware components of the computer system and including a representation of an interoperability test;
applying the interoperability test to the representation of the proposed software component; and
generating a report including results of the applying of the interoperability test.

13. The method of claim 12, wherein the representation of the proposed software component includes operating parameters for the proposed software component.

14. The method of claim 12, wherein the representation of the proposed software component includes operating parameters for the proposed hardware component.

15. The method of claim 12, wherein the testing model comprises a jagged array, and further wherein the representation of the proposed software component comprises a row of the jagged array.

16. The method of claim 15, wherein operating parameters for the proposed software component are stored in elements of the jagged array row.

17. The method of claim 16, wherein the representation of the interoperability test comprises another row of the jagged array.

18. The method of claim 17, further including storing the results of the applying into the jagged array.

19. The method of claim 18, wherein the storing includes modifying the test row of the jagged array to provide visual cues of the results of the applying.

20. The method of claim 12, wherein the generating includes creating a report that provides visual indicators of the results of the applying including a level of severity of a determined interoperability problem for the proposed software component.

21. The method of claim 12, wherein the generating includes creating new software parameters or indicators of the applying including a level of optimization of a determined interoperability problem for the proposed software component.

22. The method of claim 12, wherein the generating includes creating new hardware parameters or indicators of the applying including a level of optimization of a determined interoperability problem for the proposed software component.

23. A computer-based method for testing provisioning of a service component within a computer system, comprising:
linking a testing system having a remote testing agent to a digital communications network;
receiving a request for services provisioning testing on a computer system;
determining a set of operating parameters for the service component;
collecting hardware and software parameters for the computing system;
developing provisioning tests based on the collected hardware and software parameters;
applying the provisioning tests to the operating parameters of the service component; and
generating a provisioning report based on the applying of the tests.

24. The method of claim 23, wherein the developing includes utilizing at least a portion of the collected hardware and software parameters as testing parameters.

25. The method of claim 24, further including building a testing model including representations of the provisioning tests and the service component including the operating parameters.

26. The method of claim 25, wherein the testing model comprises a jagged array and the representation of the service component includes a row in the jagged array with operating parameters stored in row elements.

27. The method of claim 26, further including storing results of the applying into the jagged array.

28. The method of claim 23, wherein the provisioning report includes visual indicators of results of the applying including levels of provisioning success.

29. The method of claim 23, wherein the provisioning report includes creating new hardware or software parameters or indicators of the applying including a level of optimization of a determined provisioning problem.

30. A computer-based method for testing operability of a software component within a computer system, comprising:
linking a testing system having a remote testing agent to a digital communications network;
receiving a request for interoperability testing for a software component proposed to be installed on a computing system;
determining a set of operating parameters for the software component;
collecting hardware and software parameters for the computing system;
developing interoperability tests based on the collected hardware and software parameters;
applying the interoperability tests to the operating parameters of the software component; and
generating an interoperability report based on the applying of the tests.

31. The method of claim 30, wherein the developing includes utilizing at least a portion of the collected hardware and software parameters as testing parameters.

32. The method of claim 31, further including building a testing model including representations of the interoperability tests and the software component including the operating parameters.

33. The method of claim 32, wherein the testing model comprises a jagged array and the representation of the software component includes a row in the jagged array with operating parameters stored in row elements.

34. The method of claim 33, further including storing results of the applying into the jagged array.

35. The method of claim 30, wherein the interoperability report includes visual indicators of results of the applying including levels of interoperability.

36. The method of claim 30, wherein the interoperability report includes creating new hardware or software parameters or indicators of the applying including a level of optimization of a determined interoperability problem.

37. A software testing system for determining software interoperability, comprising:
means for building a testing model of a computer system including a representation of a proposed software component, a representation of software components of the computer system, and a representation of hardware components of the computer system and including a representation of an interoperability test;
means for applying the interoperability test to the representation of the proposed software component and
means for generating a report including results of the applying of the interoperability test.

38. The system of claim 37, wherein the testing model comprises a jagged array, and further wherein the representation of the proposed software component comprises a row of the jagged array.

39. The system of claim 38, further including means for storing the testing model and for storing the results of the applying in the jagged array.

40. The system of claim 37, wherein the generating means includes means for creating a report that provides visual indicators of the results of the applying including a level of severity of a determined interoperability problem for the proposed software component.

41. The method of claim 37, wherein the generating includes means for creating new hardware or software parameters or indicators of the applying including a level of optimization of a determined interoperability problem.

42. A computer-based method for testing user rights and access within a computer system for provisioning of computing services with hardware and software components of a computer system, comprising:
building a testing model of a plurality of users and their settings including a representation of a proposed service component, a representation of software components of the computer system, and a representation of hardware components of the computer system and including a representation of a user services provisioning tests;
applying the user services provisioning test to the representation of the proposed software and hardware component; and
generating a report including results of the applying of the user services provisioning test.

43. The method of claim 42, wherein the representation of the proposed user service component includes operating parameters for the proposed software component.

44. The method of claim 42, wherein the representation of the proposed user service component includes operating parameters for the proposed hardware component.

45. The method of claim 42, wherein the user services testing model comprises a jagged array, and further wherein the representation of the proposed user service component comprises an element or a row of the jagged array.

46. The method of claim 45, wherein operating parameters for the proposed user service component are stored in an element or elements of the jagged array row.

47. The method of claim 46, wherein the representation of the user services provisioning test comprises another row of the jagged array.

48. The method of claim 47, further including storing the results of applying into the jagged array.

49. The method of claim 48, wherein the storing includes modifying the test row of the jagged array to provide visual cues of the results of the applying.

50. The method of claim 42, wherein the generating includes creating a report that provides visual indicators of the results of the applying including a level of severity of a determined user services provisioning problem for the proposed user service component.

51. The method of claim 42, wherein the generating includes creating new user settings of the applying including a level of optimization of a determined user services provisioning problem for the proposed user service component.

52. The method of claim 42, wherein the generating includes creating new hardware or software parameters or indicators of the applying including a level of optimization of a determined user services provisioning problem for the proposed user service component.
